(19) United States
(12) Patent Application Publication
(10) Pub. No.: US 2009/0165403 A1
(43) Pub. Date: Jul. 2, 2009

(54) Metal Fin Pipe Foundation Apparatus and Method

(75) Inventor: Gary L. Reinert, SR., Las Vegas, NV (US)

Correspondence Address: THE WEBB LAW FIRM, P.C., 700 KOPPERS BUILDING, 436 SEVENTH AVENUE, PITTSBURGH, PA, 15219, US

(73) Assignee: MFPF, Inc., Las Vegas, NV (US)

(21) Appl. No.: 12/197,467

(22) Filed: Aug. 25, 2008

Related U.S. Application Data
(63) Continuation of application No. 11/071,005, filed on Mar. 3, 2005, now abandoned.
(60) Provisional application No. 60/551,296, filed on Mar. 5, 2004.

(51) Int. Cl. E02D 5/74; B23P 11/00

(52) U.S. Cl. 52/165; 29/897.3; 52/741.1

(57) ABSTRACT

Disclosed are a metal fin pipe foundation apparatus and method for airport approach lighting and method of making, using, and installing a metal fin pipe foundation for airport approach lighting. The metal fin pipe foundation (MFPF) of the present invention requires a small 16 inch diameter hole to be drilled approximately 8 feet deep. The MFPF, in one aspect, consists of 16 inch diameter schedule 30 pipe 6 feet long with two (2) ⅜ inch thick flat plate fins which are 6 feet, in length, and which are welded to the 16 inch schedule 30 pipe. A top plate 5 feet in length, 1 foot 6 inches in width, and ¾ inch thick is attached by welding the top plate to the top of the 16 inch pipe and the top of the ⅜ inch fins. After the MFPF of the present invention is completely fabricated, it is dipped in hot galvanizing to protect the raw steel. This coating of galvanizing protects the MFPF for 75 years. The MFPF of the present invention can be fabricated off site and shipped to the airport ready for installation. The 16 inch diameter hole is drilled, which requires soil being extracted from the hole, and the soil is placed next to the drilled shaft hole to be placed back into the 16 inch diameter pipe after the MFPF is installed. The 16 inch diameter pipe is used as the junction box for housing the electrical transformer to provide power to the structure to be mounted to the top plate of the MFPF of the present invention. The MFPF then is installed by pushing it into the previous 16 inch drilled hole, which acts as a guide to keep it perfectly straight as it is being installed. The structure of the present invention can be immediately erected and ready for use within 6 hours. The present invention eliminates large excavation, removes soil by trucking, placing of reinforced rods, trucking of concrete, and placing of concrete during off hours and requires twenty-eight (28) days for curing before the foundation can be used.

This patent application is a continuation-in-part of prior, co-pending U.S. Patent Application No. 60/551,296 filed Mar. 5, 2004.

### BACKGROUND OF THE INVENTION

1. Technical Field

This invention relates to a metal fin pipe foundation for airport approach lighting and further relates to a method of making, using, and installing a metal fin pipe foundation for airport approach lighting. This invention relates to an airport approach light installation apparatus and method for the installation of finned airport approach light tubular foundations. In one aspect, this invention relates to a method of installation of foundations in the ground utilizing the apparatus and method of the invention. In one aspect, this invention relates to the utilization of the apparatus and methods of this invention for the installation of novel SAFE Foundations (Secure Anchoring and Foundation Equipment) for airport approach lights and towers.

2. Background

Airport MG20 approach light foundations and towers to support approach lights for visual guidance of aircraft to airports are very critical and must be installed for an airport runway to land aircraft.

Timing and minimum construction time are very important to airports.

The FAA Federal Aviation Administration of the United States has needed a fast method to install foundations because of the minimum timing required to complete the approach lighting installation.

The existing foundations used for airport approach lighting are installed by excavating a large area and removing the soil by means of trucking the soil off airports. The conventional installation method requires closing runways or taxiways down to gain access into and around the heavily secured airport. Reinforcing steel rods must be trucked in and placed in the excavated area. These reinforcing rods must be placed in a confined and exact location. Wooden forms must be placed around the excavated area to the exact size required for the foundation. Concrete must be trucked in from off-site to the airport premises to a location at the approach end of an airport runway, which is a restricted area, and work must be performed at off hours, normally 10:00 PM-6:00 AM. The off-hours timing requires concrete suppliers to open their concrete plants to coordinate with the off-hours schedule. Concrete provided during the off-hours schedule typically costs as much as eight (8) times the price of concrete during normal daily operations.

Special metal junction boxes, for electrical apparatus required for the operation of the structures, are mounted to the foundation and must be placed in the excavated hole prior to the concrete being placed.

During the placing of the concrete, care must be taken not to disturb the location of the junction box and anchor bolts. The junction box, in one aspect having dimensions of 16″×24″, houses the electrical transformers to power the structure to be mounted on the concrete foundation.

Special anchor bolts also must be placed into the excavated hole prior to the concrete being placed.

After the concrete is carefully placed, which is typically performed in the evening hours, and which further requires special portable light plants, the concrete finish surface must be hand finished to a smooth surface. The hand finish requires a special tradesman to finish the surface. The hand finish process from start to finish takes approximately 12 hours.

The concrete must cure for twenty-eight (28) days prior to erecting or placing a structure on the concrete or mounting a structure to the anchor bolts.

The concrete foundation process is very expensive and time consuming and accordingly does not facilitate an efficient schedule for installation of the airport approach lights.

### INTRODUCTION TO THE INVENTION

There is a need for an apparatus and method for installing approach lights which are less expensive and much easier to install as contrasted to concrete.

It is also an object of the present invention to provide apparatus and method for installing an approach light foundation of the present invention which is less expensive and much easier to handle while providing any length required.

It is another object of the present invention to provide apparatus and method for installing an approach light foundation of the present invention that can be readily available in the field and easy to assemble in the field to match any required length, eliminating the need to install special lengths.

It is yet another object of the present invention to provide apparatus and methods for installing an approach light foundation of the present invention that eliminate the need to drill a deeper earthen hole, when the installer is forced to use a longer anchoring device, by providing the installer with apparatus and methods to match any length required by the foundation to be installed with it.

It is still another object of the present invention to provide apparatus and methods for installing an approach light foundation of the present invention that can meet any unforeseen length requirement because of unexpected soil conditions.

It is a further object of the present invention to provide apparatus and methods for installing a approach light foundation of the present invention which always exerts the installation forces upon the soil instead of exerting the forces upon its components.

It is yet a further object of the present invention to provide apparatus and methods for installing an approach light foundation of the present invention which is easily retrievable, even when its top portion falls down below the surface, at the top of the earthen hole it was installed in.

These and other objects of the present invention will become apparent to those skilled in the art from a careful review of the detailed description which follows.

### SUMMARY OF THE INVENTION

The present invention provides a metal fin pipe foundation apparatus and method for airport approach lighting and method of making, using, and installing a metal fin pipe foundation for airport approach lighting.

The Metal Fin Pipe Foundation (MFPF) of the present invention eliminates large expenses for excavation, removing soil by trucking, placing of reinforcing rods, trucking of concrete and placing of concrete during off hours and requires twenty-eight (28) days for curing before the foundation can be used.

The metal fin pipe foundation (MFPF) of the present invention requires a small 16 inch diameter hole to be drilled approximately 8 feet deep.

The MFPF, in one aspect, consists of 16 inch diameter schedule 30 pipe 6 feet long with two (2) ⅜ inch thick flat plate fins which are 6 feet, in length, and which are welded to the 16 inch schedule 30 pipe. A top plate 5 feet in length, 1 foot 6 inches in width, and ¾ inch thick is attached by welding the top plate to the top of the 16 inch pipe and the top of the ⅜ inch fins.

After the MFPF of the present invention is completely fabricated, it is dipped in hot galvanizing to protect the raw steel. This coating of galvanizing protects the MFPF for 75 years.

The MFPF of the present invention can be fabricated off site and shipped to the airport ready for installation.

The 16 inch diameter hole is drilled, which requires soil being extracted from the hole, and the soil is placed next to the drilled shaft hole to be placed back into the 0.16 inch diameter pipe after the MFPF is installed.

The 16 inch diameter pipe is used as the junction box for housing the electrical transformer to provide power to the structure to be mounted to the top plate of the MFPF of the present invention.

The MFPF then is installed by pushing it into the previous 16 inch drilled hole, which acts as a guide to keep it perfectly straight as it is being installed.

The structure of the present invention can be immediately erected and ready for use within 6 hours.

The present invention eliminates large excavation, removes soil by trucking, placing of reinforced rods, trucking of concrete, and placing of concrete during off hours and requires twenty-eight (28) days for curing before the foundation can be used.

### BRIEF DESCRIPTION OF THE DRAWINGS

FIG. 1 is sectional elevational view of a metal fin pipe foundation of the present invention.

FIG. 2 is top view of a metal fin pipe foundation of the present invention.

FIG. 3 is sectional view of a metal fin pipe foundation of the present invention taken along section “A”-“A”.

FIGS. 4 through 34 show further embodiments of a metal fin pipe foundation of the present invention.

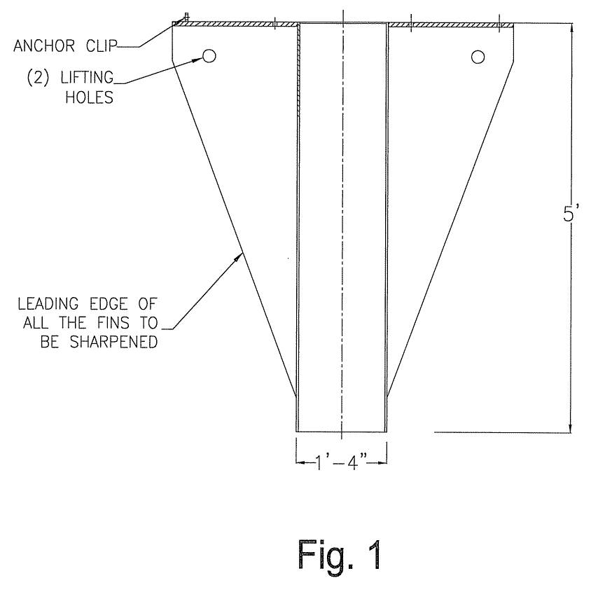

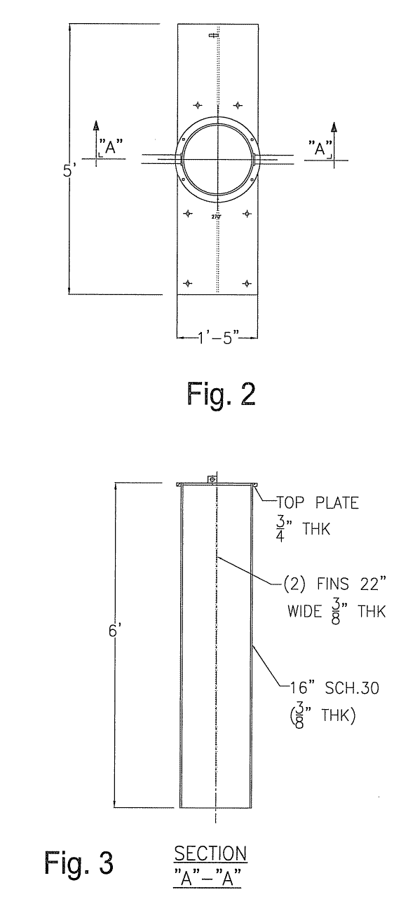

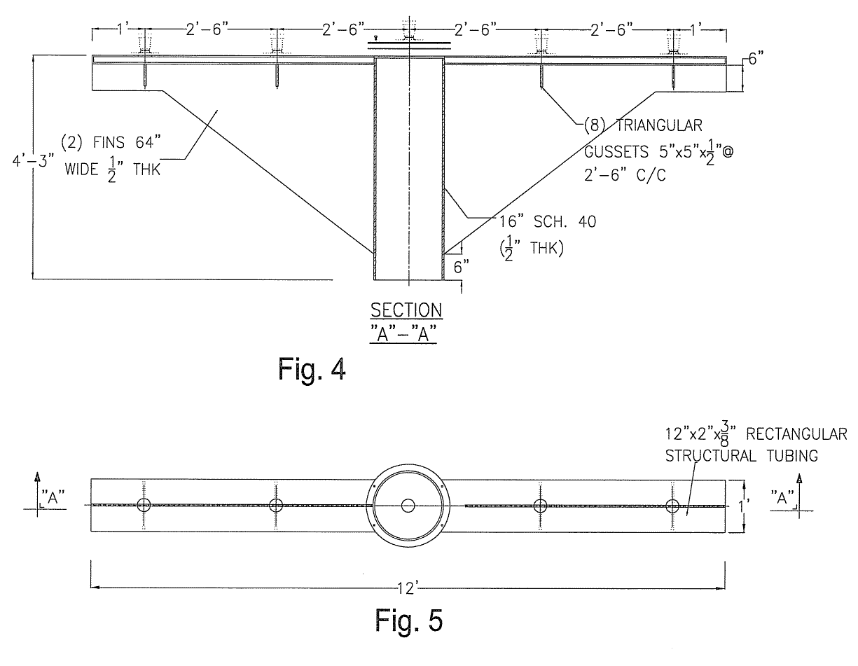

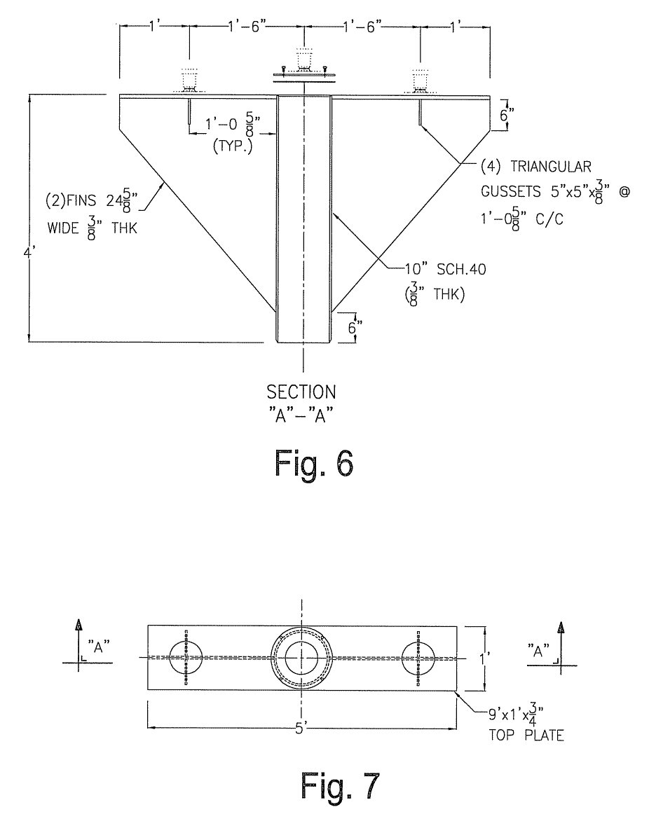

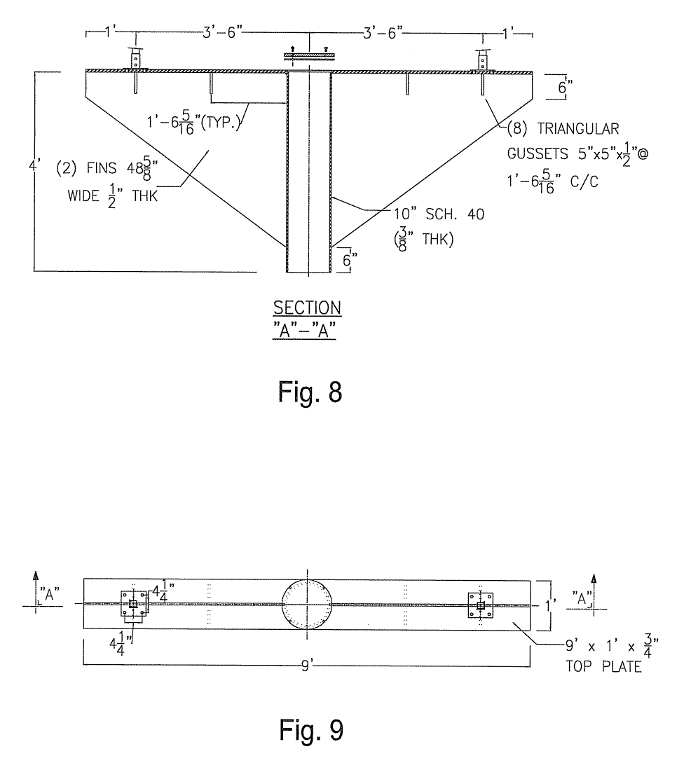

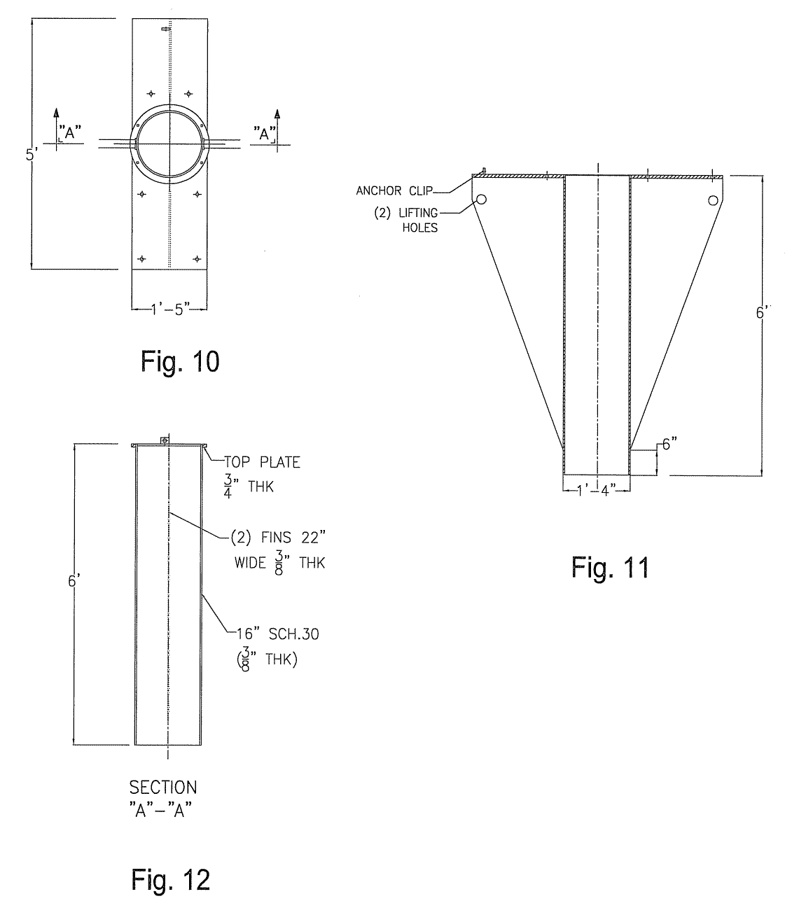

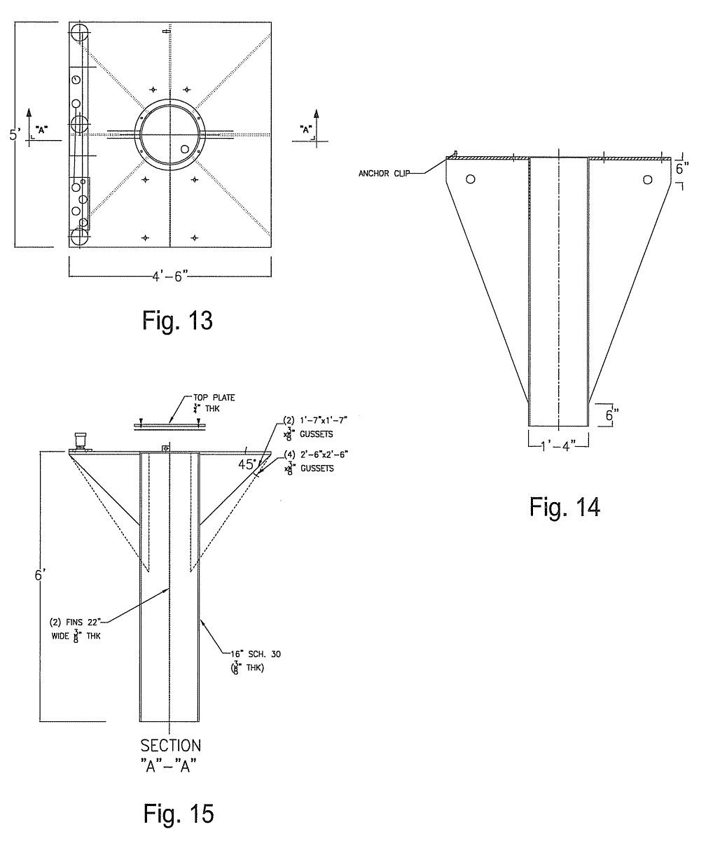

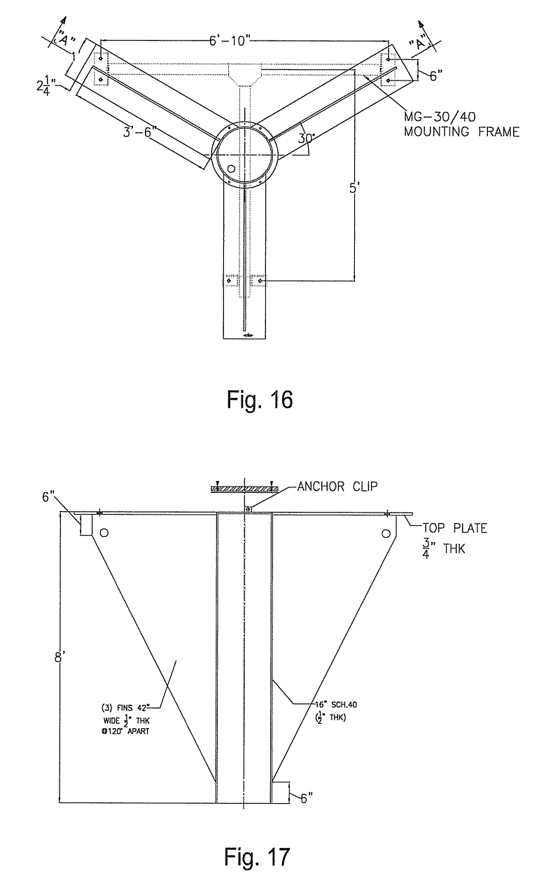

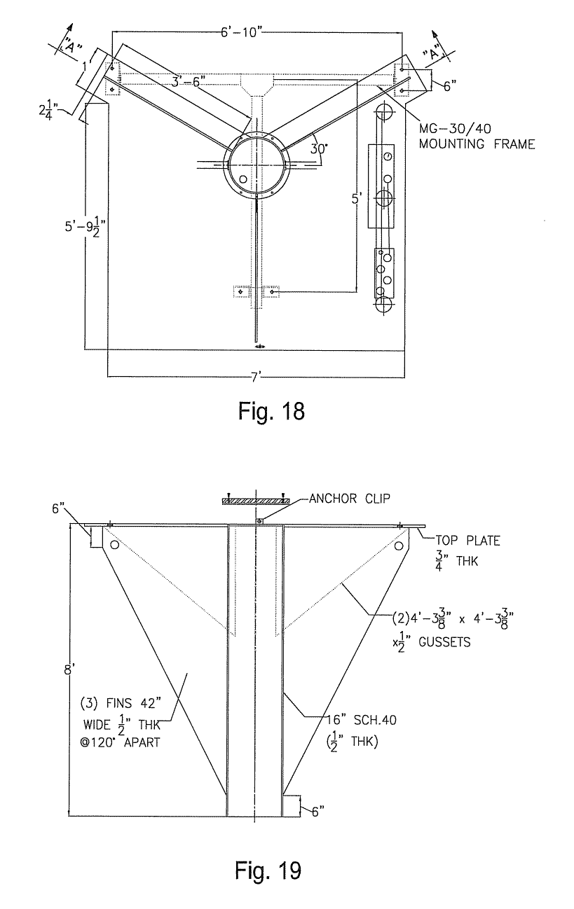

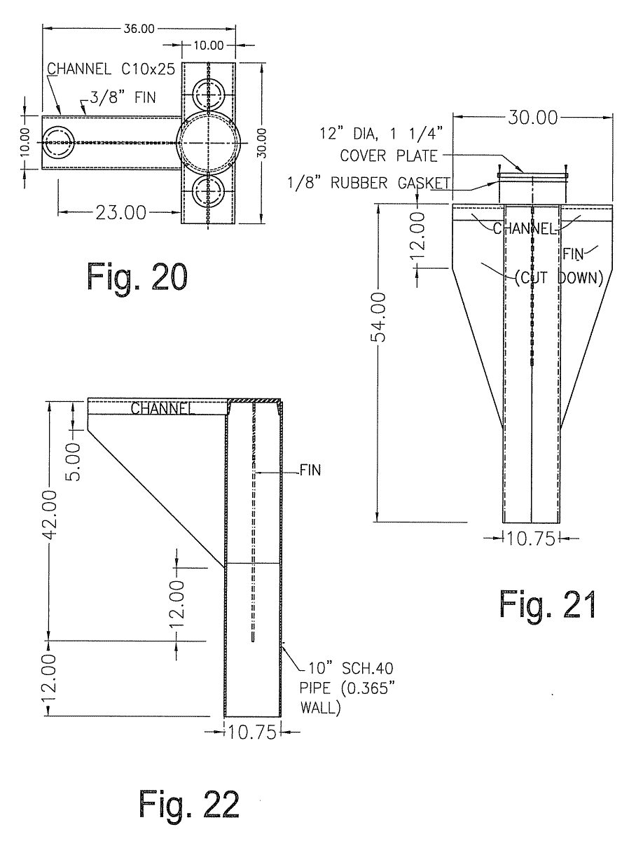

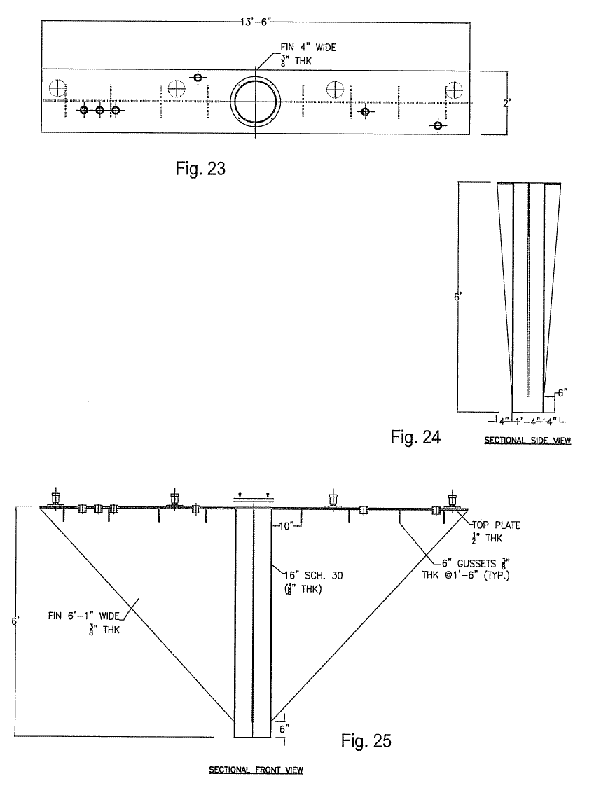

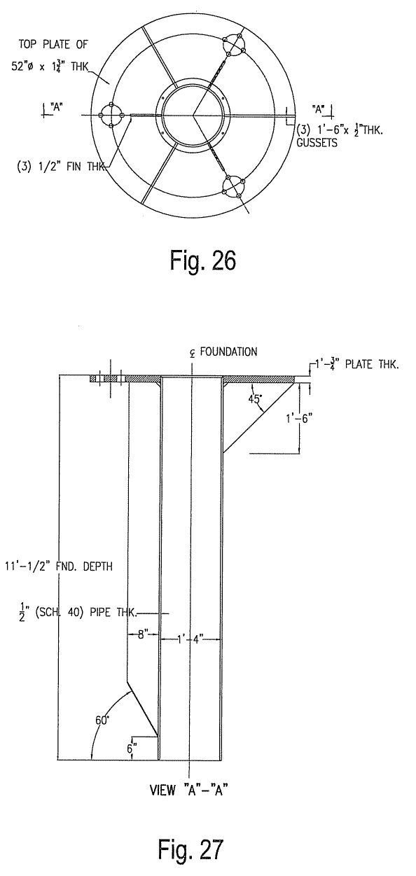

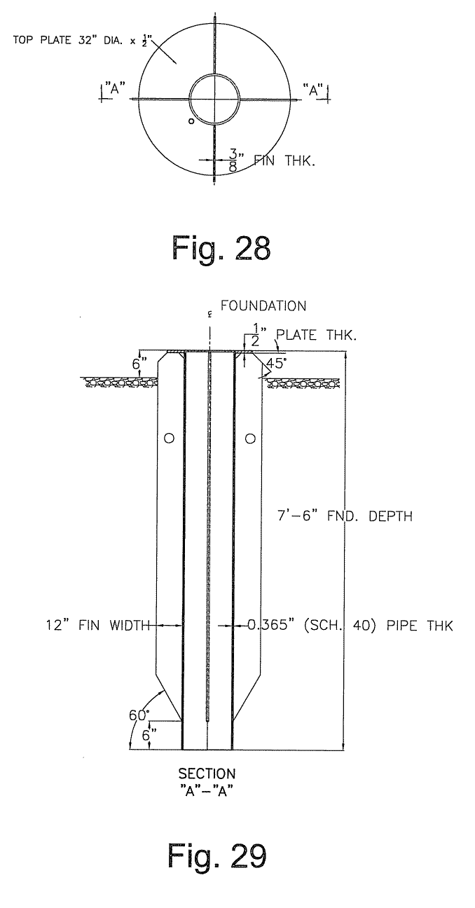

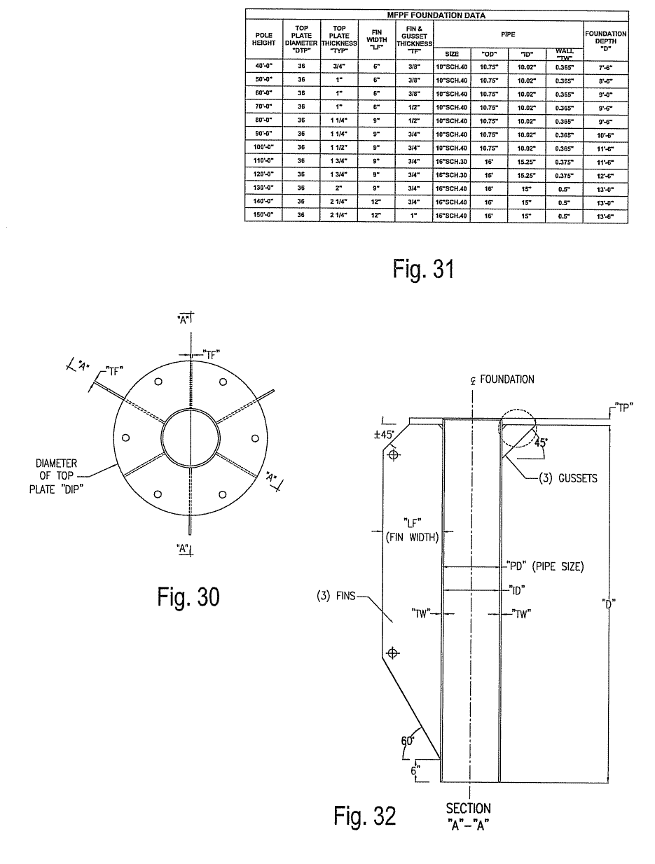

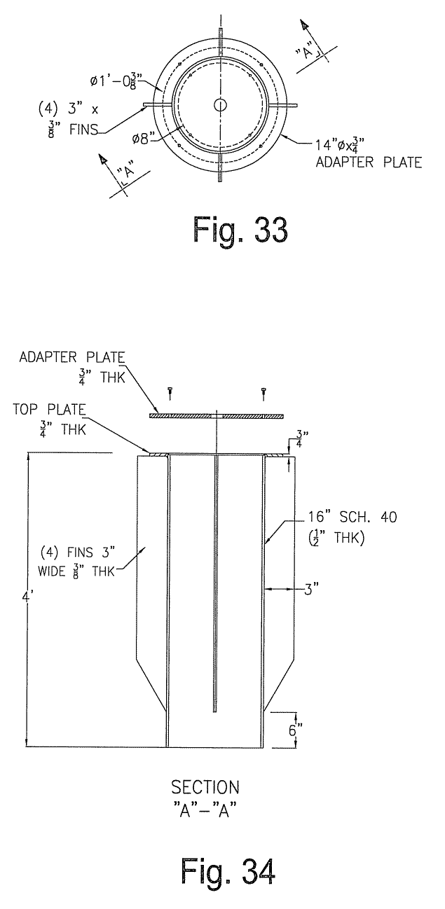

### DETAILED DESCRIPTION

The present invention provides an airport approach light installation apparatus and method for the installation of finned airport approach light tubular foundations. In one aspect, the present invention provides a method of installation of foundations in the ground utilizing the apparatus and method of the invention. In one aspect, the present invention provides for the utilization of the apparatus and methods of the invention for the installation of novel SAFE Foundations (Secure Anchoring and Foundation Equipment) for airport approach lights and towers.

Anchoring devices and SAFE Foundations (Secure Anchoring and Foundation Equipment), as well as the methods of installation for the anchoring devices and suitable foundations are fully described in U.S. Pat. Nos. 4,843,785, 4,882,891, 4,974,997, 5,570,975, 5,660,504, 5,733,068, and 5,944,452, which are hereby incorporated by reference and incorporated herein as if set out in their entirety.

The installation of an approach light foundation of the present invention requires utilizing an anchoring device of the required length, which depends on the length of the approach light foundation of the present invention. In many instances and occasions, the installation of the approach light foundation of the present invention requires utilizing one, two, or more pairs of additional conventional anchoring devices, which means the installation of a approach light foundation of the present invention sometimes requires three, five, or more conventional anchoring devices instead of a single one.

Tubular foundations are utilized for supporting structures, e.g., lighting poles, across-the-highway traffic signs, communication towers, and others. Tubular foundations are installed in the ground by pressing them into the soil utilizing hydraulic power means and a pre-stressed, conventional anchoring device, which is been anchored, i.e., pre-stressed inside a pre-augered earthen hole.

Tubular foundations are fabricated in a multitude of lengths, requiring the availability of anchoring device of the proper length for each tubular foundation to be installed, requiring a multitude of conventional, anchoring device lengths. Anchoring devices are pre-stressed inside a pre-augered earthen hole.

Anchoring devices typically are made in one piece, consisting of a one-piece, standard threaded rod with an anchorhead attached at the end of the rod and of a one-piece pipe column, with fins. These one-piece anchoring devices have to be transported to the foundation installation site.

Anchoring devices may be made in one-piece full lengths, making them expensive to transport and to handle.

Anchoring devices further may be manufactured in a limited number of standard lengths, while the approach light foundation of the present invention installed with these devices are manufactured in a multitude of lengths, in increments of six inches. When the installer cannot find a anchoring device length, he/she is forced either to install a longer standard length than the actual length required, or the installer is forced to have one special anchoring device made to order, i.e., specially custom ordered of the required size, which means more expensive and time consuming installations.

Yet another drawback is when the installer is forced to utilize a longer-than-required anchoring device. He or she also is forced to drill a deeper earthen hole to accommodate the extra length of the non-standard anchoring device. This translates into additional costs.

Still another drawback exists despite the fact that the characteristics of the soil are known in advance where the approach light foundation of the present invention is to be installed and the length of anchoring device is determined. After augering the earthen hole, unexpected soil conditions may be encountered, e.g., an unexpected location of the water table, or reaching an unexpected layer of softer, i.e., weaker soils. In such situations, deeper holes have to be augered, requiring longer anchoring devices, standard or not, to be utilized and therefore not instantly available at the installation site. These unexpected developments create installation delays as well as cost overruns.

A further drawback involves the forces required for stressing the anchoring assembly. At some point during the installation of the anchoring device, force is exerted on the components of the device, instead of being exerted upon the soil, because of its “mechanical stop” that serves as “limiting means.” This can provide false readings of the strength of the installation.

Another drawback is the need for large equipment to lift the anchor because of the weight of the long anchor assembly.

Yet a further drawback is that the anchoring device is very difficult to retrieve from inside its earthen hole, if after the installation is complete its top portion falls below grade, i.e., below the top surface of the earthen hole it was installed in.

The Metal Fin Pipe Foundation (MFPF) of the present invention eliminates large excavation, removing soil by trucking, placing of reinforced rods, trucking of concrete and placing of concrete during off hours and requires twenty-eight (28) days for curing before the foundation can be used.

The metal fin pipe foundation (MFPF) of the present invention requires a small 16 inch diameter hole to be drilled approximately 8 feet deep.

The MFPF, in one aspect, consists of 16 inch diameter schedule 30 pipe 6 feet long with two (2) ⅜ inch thick flat plate fins which are 6 feet, in length, and which are welded to the 16 inch schedule 30 pipe. A top plate 5 feet in length, 1 foot 6 inches in width, and ¾ inch thick is attached by welding the top plate to the top of the 16 inch pipe and the top of the ⅜ inch fins.

After the MFPF of the present invention is completely fabricated, it is dipped in hot galvanizing to protect the raw steel. This coating of galvanizing protects the MFPF for 75 years.

The MFPF of the present invention can be fabricated off site and shipped to the airport ready for installation.

The 16 inch diameter hole is drilled, which requires soil being extracted from the hole, and the soil is placed next to the drilled shaft hole to be placed back into the 16 inch diameter pipe after the MFPF is installed.

The 16 inch diameter pipe is used as the junction box for housing the electrical transformer to provide power to the structure to be mounted to the top plate of the MFPF of the present invention.

The MFPF then is installed by pushing it into the previous 16 inch drilled hole, which acts as a guide to keep it perfectly straight as it is being installed.

The structure of the present invention can be immediately erected and ready for use within 6 hours.

The MFPF of the present invention are designated in the trade as MG20; EMT-3-4-5; PAPI (precision approach path indicator) and Power Control Center for PAPI.

The MG20-30-40; EMT 3-4-5 Light, PAPI, Power Control Center, Control Building, RVR, Glide Slope, Power Central for RVR, and localizer foundations are all similar in method and means. The differences are in the top plates that require a different design for each structure to be mounted to it; All will have the same name MFPF for MG20; MFPF for EMT 3-4-5 Light, MFPF for PAPI, MFPF for Power Control Center and all the above.

The novel anchoring apparatus and method as disclosed in co-pending U.S. patent application U.S. Ser. No. 10/294,429 filed Nov. 14, 2002 is hereby incorporated by reference and included herein as if set forth in its entirety.

The apparatus and method of the present invention as shown and illustrated in the detailed description of the specification and the accompanying figures of the drawings are not intended to be limited to the specific examples shown and described, but the apparatus and method of the present invention are intended to include the novel developments encompassed by the claims which follow and equivalents thereof.

What is claimed is:

1. An airport approach light apparatus comprising a metal fin pipe foundation.

2. An airport approach light apparatus as set forth in claim 1, further comprising a top plate.

3. An airport approach light apparatus as set forth in claim 2, wherein said top plate is welded to said pipe foundation.

4. An airport approach light apparatus as set forth in claim 3, wherein said pipe foundation is composed of galvanized steel.

5. An airport approach light apparatus as set forth in claim 1, wherein said pipe foundation is fabricated off site and shipped to the airport ready for installation.

6. An airport approach light apparatus as set forth in claim 3, wherein said pipe foundation consists of a 16 inch diameter schedule 30 pipe 6 feet long.

7. An airport approach light apparatus as set forth in claim 3, wherein said pipe foundation comprises a junction box housing an electrical transformer.

8. A method of providing an airport approach light apparatus, comprising a metal fin pipe foundation.

9. A method as set forth in claim 8, further comprising providing a top plate.

10. A method as set forth in claim 9, wherein said top plate is welded to said pipe foundation.

11. A method as set forth in claim 10, wherein said pipe foundation is composed of galvanized steel.

12. A method as set forth in claim 11, wherein said airport approach light apparatus is fabricated off site and shipped to the airport ready for installation.

13. A method as set forth in claim 12, wherein said pipe foundation consists of a 16 inch diameter schedule 30 pipe 6 feet long.

14. A method as set forth in claim 13, wherein said pipe foundation comprises a junction box housing an electrical transformer.

15. A method of installing an airport approach light, comprising inserting a mutual fin pipe foundation into the ground.

16. A method of installing an airport approach light as set forth in claim 15, comprising providing a segmented anchor.

17. A method of installing an airport approach light as set forth in claim 15, comprising installing said pipe foundation by pushing into the ground.

18. A method of installing an airport approach light as set forth in claim 15, comprising installing said pipe foundation by pulling into the ground.

19. A method of installing an airport approach light as set forth in claim 15, wherein said pipe foundation consists of a 16 inch diameter schedule 30 pipe 6 feet long.

20. A method of installing an airport approach light as set forth in claim 15, wherein said pipe foundation is fabricated off site and shipped to the airport ready for installing.
